(19) United States
(12) Patent Application Publication
(10) Pub. No.: US 2026/0074467 A1
(43) Pub. Date: Mar. 12, 2026

(54) PROTECTOR FOR ENHANCED SMALL FORM FACTOR PLUGGABLE CONNECTORS

(71) Applicant: AT&T Intellectual Property I, L.P., Atlanta, GA (US)

(72) Inventors: Christopher Potts, Alpharetta, GA (US); Gavin A. Grant, Cumming, GA (US); Brandon Hilliard, Canton, GA (US); Shawn Nall, Loganville, GA (US); George Goehring, Atlanta, GA (US)

(21) Appl. No.: 18/830,358

(22) Filed: Sep. 10, 2024

(51) Int. Cl. H01R 13/639

(52) U.S. Cl. CPC H01R 13/6397

(57) ABSTRACT

Examples of the present disclosure provide a pair of mechanical protectors or guards that fits around an SFP plug and an SFP socket. In one example, an apparatus includes a first protector sized to fit around a small form factor pluggable plug and a second protector, separate from the first protector and sized to frame a small form factor pluggable socket. The first protector includes a first ring defining a first aperture and a key formed in an outside perimeter of the first ring. The second protector comprises a second ring defining a second aperture and a lock formed in an inside perimeter of the second ring, wherein the lock is sized and shaped to engage the key.

The present disclosure relates generally to fiber broadband network infrastructure, and relates more particularly to an apparatus for protecting small form factor pluggable connectors against breakage due to user error.

### BACKGROUND

Fiber broadband is a type of network architecture that uses optical fiber to provide all or part of the local loop used for last mile telecommunications. Small form factor pluggable (SFP) connectors are used in fiber broadband networks to connect customers'Internet hubs to the fiber broadband network service provider's fiber lines. SFP is a compact, hot-pluggable network interface module format used for both telecommunication and data communications applications. Enhanced SFP (SFP+) is an enhanced version of the SFP that supports data rates up to 16 Gbit/s.

### SUMMARY

Examples of the present disclosure provide a pair of mechanical protectors or guards that fits around an SFP plug and an SFP connector. In one example, an apparatus includes a first protector sized to fit around a small form factor pluggable plug and a second protector, separate from the first protector and sized to frame a small form factor pluggable socket. The first protector includes a first ring defining a first aperture and a key formed in an outside perimeter of the first ring. The second protector comprises a second ring defining a second aperture and a lock formed in an inside perimeter of the second ring, wherein the lock is sized and shaped to engage the key.

In another example, an apparatus includes a first protector sized to fit around a small form factor pluggable plug and a second protector, separate from the first protector and sized to frame a small form factor pluggable socket. The first protector includes a first ring defining a first aperture, wherein a surface of the first aperture is rubberized, and a key formed in an outside perimeter of the first ring, wherein the key comprises a feature that protrudes from the outside perimeter of the first ring. The second protector includes a second ring defining a second aperture and a lock formed in an inside perimeter of the second ring, wherein the lock comprises an indentation in the inside perimeter of the second ring that has a similar size and a similar shape as the feature.

In another example, an apparatus includes a small form factor pluggable plug for connecting to a small form factor pluggable connector and a protector fitted onto an end of the small form factor pluggable plug. The protector includes a first ring defining a first aperture in which the small form factor pluggable plug fits and a key formed in an outside perimeter of the first ring, wherein the key is sized and shaped to engage a lock on a protector that is installed on a small form factor pluggable connector.

### BRIEF DESCRIPTION OF THE DRAWINGS

The teachings of the present disclosure can be readily understood by considering the following detailed description in conjunction with the accompanying drawings, in which:

FIG. 1A illustrates a cross sectional view of an example pair of protectors for protecting a small form pluggable connector, according to the present disclosure;

FIG. 1B illustrates a cross sectional view of the example pair of protectors of FIG. 1A in an assembled state;

FIG. 2A illustrates how the first protector and second protector of FIGS. 1A and 1B may be installed on an SFP plug and an SFP socket in an orientation to ensure proper installation of the SFP plug; and FIG. 2B illustrates how the first protector and second protector of FIGS. 1A and 1B may prevent the SFP plug from being installed in an improper orientation that may cause damage to the SFP plug.

To facilitate understanding, identical reference numerals have been used, where possible, to designate identical elements that are common to the figures.

### DETAILED DESCRIPTION

In one example, the present disclosure provides an apparatus for protecting enhanced small form factor connectors against breakage due to user error. As discussed above, fiber broadband is a type of network architecture that uses optical fiber to provide all or part of the local loop used for last mile telecommunications. Small form factor pluggable (SFP) connectors are used in fiber broadband networks to connect customers' Internet hubs to the fiber broadband network service provider's fiber lines. SFP is a compact, hot-pluggable network interface module format used for both telecommunication and data communications applications. Enhanced SFP (SFP+) is an enhanced version of the SFP that supports data rates up to 16 Gbit/s.

SFP+ plugs tend to be expensive but fragile pieces of equipment that are easily prone to breakage if improperly installed. For instance, there is typically only one “right” way to position an SFP+ plug when inserting the SFP+ plug into an SFP connector of a socket. If an installer accidentally positions the SFP+ plug the “wrong” way and applies too much force (e.g., forces the SFP+ plug too far into a connector of the socket), the SFP+ plug may break. As a growing number of fiber broadband network service providers has begun to provide “self-install” options (by which their customers may choose to install their own customer premises equipment rather than wait for a technician to be dispatched for the install), this provides a greater number of opportunities for breakage of SFP+ plugs due to mishandling and user error. For instance, inexperienced users attempting to self-install customer premises equipment may mistakenly attempt to insert the SFP+ plugs the wrong way when plugging the SFP+ plugs into SFP+ connectors, leading to breakage of the SFP+ plugs as discussed above. Between equipment costs and technician time, fiber broadband network service providers may spend hundreds of dollars per each SFP+ plug that requires replacement.

Examples of the present disclosure provide a pair of mechanical protectors or guards that fits around an SFP plug and an SFP socket. The mechanical protectors are shaped in a manner that prevents the SFP plug from being inserted into an SFP connector in the SFP socket if the SFP plug is oriented incorrectly, thereby greatly reducing the chances of the SFP plug being broken due to user error.

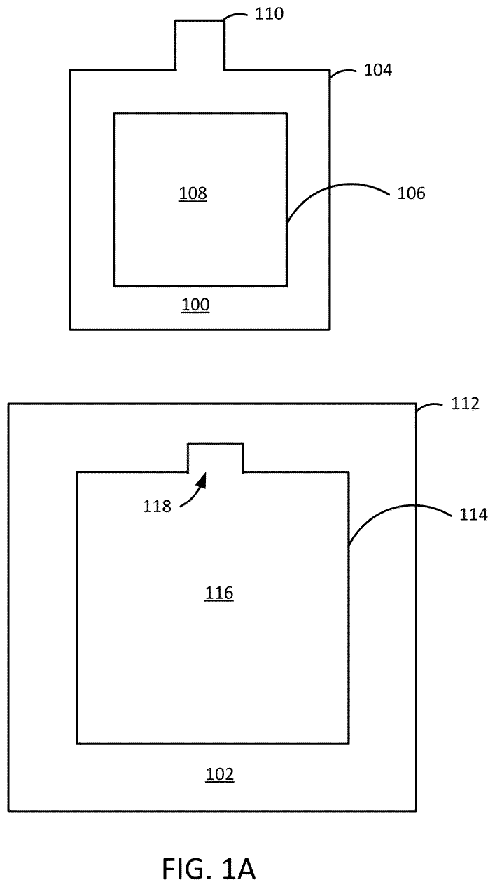

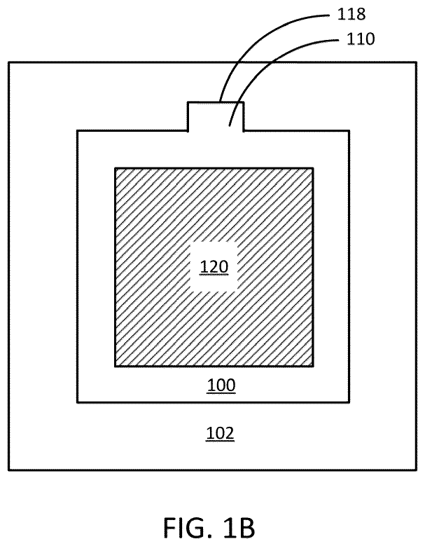

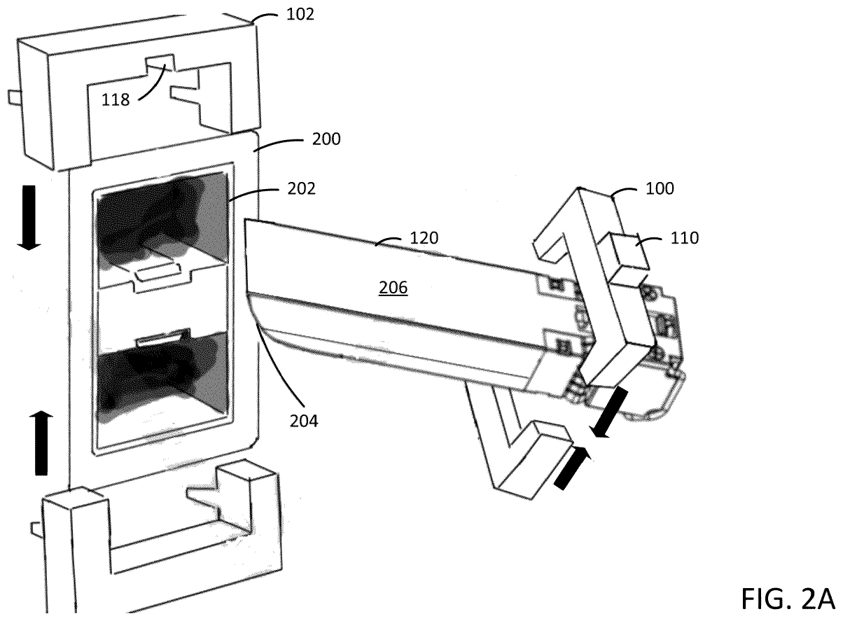

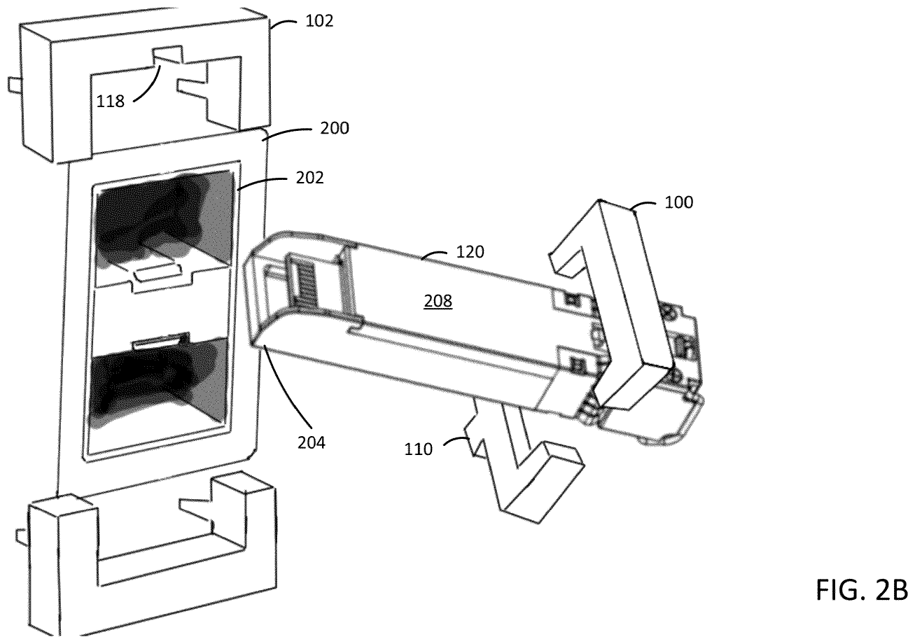

The mechanical protectors of the present disclosure may be used to protect any type of SFP connector or plug, including SFP+ connectors. Since each mechanical protector can be manufactured for a fraction of what it would cost to replace a single SFP+ plug, the mechanical protectors of the present disclosure provide a cost efficient solution for reducing breakage of SFP+ plugs. These and other aspects of the present disclosure are discussed in further detail with reference to FIGS. 1A-2B, below.

To further aid in understanding the present disclosure, FIG. 1A illustrates a cross sectional view of an example pair of protectors 100 and 102 for protecting a small form pluggable connector, according to the present disclosure. In one example, the first protector 100 is sized to fit around the end of an SFP plug, while the second protector 102 is sized to fit around the perimeter of an SFP socket.

The first protector 100 may generally comprise a rectangular ring. Thus, the outside perimeter 104 of the first protector 100 may comprise four sides, and the size of the outside perimeter 104 may be of any size. The inside perimeter 106 of the first protector 100 may comprise four sides and may be of a size that is smaller than the size of the outside perimeter 104. The inside perimeter 106 defines the boundaries of a passage or aperture 108. In one example, the inside perimeter 106 is slightly larger than a perimeter of an SFB plug, so that an end of the SFB plug may fit securely within the aperture 108 (as shown in FIGS. 2A and 2B).

In one example, one side of the outside perimeter 104 of the first protector 100 includes a key 110. The key 110 may comprise a shaped feature that protrudes from the outside perimeter 104. In the example, illustrated in FIG. 1A, the key 110 has a rectangular shape; however, in other examples, the key 110 may take shapes other than a rectangular shape, e.g., circular, semi-circular, triangular, multi-sided shapes (e.g., greater than four-sided), and the like.

The second protector 102 may also generally comprise a rectangular ring. Thus, the outside perimeter 112 of the second protector 102 may comprise four sides, and the size of the outside perimeter 112 may be of any size. The inside perimeter 114 of the second protector 102 may comprise four sides and may be of a size that is smaller than the size of the outside perimeter 112. The inside perimeter 114 defines the boundaries of a passage or aperture 116. In one example, the inside perimeter 114 is slightly larger than the outside perimeter 104 of the first protector 100, so that the first protector 100 may fit securely within the aperture 116 (as shown in FIG. 1B).

In one example, one side of the inside perimeter 114 of the second protector 102 includes a lock 118. The lock 118 may comprise a notch or indentation in the inside perimeter 114 that is sized and shaped to receive the key 110 on the first protector 100. In the example, illustrated in FIG. 1A, lock 118 has a rectangular shape; however, in other examples, the lock 118 may take shapes other than a rectangular shape, as long as the size and shape of the lock 118 matches the size and shape of the key 110 (e.g., same or similar in size and shape to accommodate a slight tolerance to allow mating of the key 110 to the lock 118).

FIG. 1B illustrates a cross sectional view of the example pair of protectors 100 and 102 of FIG. 1A in an assembled state. As illustrated, the first protector 100 may be fitted around an SFP plug 120, i.e., so that the SFP plug 120 passes through the aperture 108. In one example, the inside perimeter 106 of the first protector 100 may include features to assist in holding the SFP plug 120 in place within the aperture 108, e.g., so that the first protector 100 does not slip along the SFP plug 120. For instance, the inside perimeter 106 may include a rubberized surface to facilitate a friction fit, or the inside perimeter 106 may include small protrusions or indentations positioned to engage with features (e.g., ridges or the like) on the SFP plug 120.

The second protector 102 may be positioned around the outside perimeter of an SFP socket (not visible in FIG. 1B), like a frame (e.g., such that the inside perimeter 114 of the second protector 102 “frames” the SFP socket). In one example, the second protector 102 may be affixed to a surface (e.g., a wall) in which the SFP socket is installed, such as by fastener (e.g., nail, screw, or the like) or by adhesive. When the SFP plug 120 is inserted into a connector in an SFP socket (not shown in FIG. 1B), the first protector 100 may be positioned so that the key 110 lines up with and engages the lock 118 on the second protector 102. Engagement of the lock 118 and key 110 ensures that the SFP plug 102 is properly oriented when being inserted into the connector and will allow the SFP plug to 120 to be fully inserted into the connector. If the SFP plug 120 is oriented in any other orientation, the key 110 will not engage the lock 118, and this lack of engagement will prevent the SFP plug 120 from being fully inserted into the connector (and likely breaking due to improper orientation).

In one example, the first protector 100 and the second protector 102 may be formed from a plastic; however, in other examples, the first protector 100 and the second protector 102 may be formed from a material other than plastic. Moreover, although each of the first protector 100 and the second protector 102 is illustrated in FIG. 1A as a unitary piece, in another example, one or more of the first protector 100 and the second protector 102 may be formed in two or more pieces (e.g., as illustrated in FIGS. 2A and 2B).

FIG. 2A illustrates an exploded, isometric view of the pair of example protectors 100 and 102 illustrated in FIGS. 1A and 1B. More specifically, FIG. 2A illustrates how the first protector 100 and second protector 102 of FIGS. 1A and 1B may be installed on an SFP plug 120 and an SFP socket 200 in an orientation to ensure proper installation of the SFP connector plug.

As illustrated in FIG. 2A, the first protector 100 is positioned around the SFP plug 120, at a distance from the end 204 of the SFP plug 120. The first protector 100 is installed so that the key 110 is aligned with a “top” side 206 of the SFP plug 120 (e.g., a side on which the pins of the SFP plug 120 are not exposed).

In the example illustrated in FIG. 2A, the first protector 100 is manufactured in two pieces rather than in a single piece as illustrated in FIGS. 1A and 1B. In this case, the two pieces of the first protector 100 may fit around the SFP plug 120 and attach to each other by clips, magnets, or other fastening means (as illustrated by the shaded arrows).

The second protector 102 is positioned around the SFP socket 200, so that the SFP socket 200 is “framed” by the second protector 102. The second protector 102 is installed so that the lock 118 is aligned with a “top” side of the SFP socket 200.

In the example illustrated in FIG. 2A, the second protector 102 is manufactured in two pieces rather than in a single piece as illustrated in FIGS. 1A and 1B. In this case, the two pieces of the second protector 102 may fit around the SFP socket 200 and attach to each other by clips, magnets, or other fastening means (as illustrated by the shaded arrows).

It should be noted that although FIG. 2A illustrates the key 110 and the lock 118 as being aligned with the tops of the SFP plug 120 and SFP socket 200, respectively, the orientation could be flipped. For instance, the key 110 and the lock 118 could instead be aligned with the bottoms of the SFP plug 120 and SFP socket 200, respectively (or even the sides, in some cases). The important thing is key 110 and lock 118 must either both be aligned with the tops of the SFP plug 120 and SFP socket 200, or both be aligned with the bottoms of the SFP plug 120 and SFP socket 200. If one of the key 110 and lock 118 is aligned with the top, and the other of the key 110 and the lock 118 is aligned with the bottom, the SFP plug will not be able to be installed properly.

As illustrated in FIG. 2A, when the SFP plug 120 is inserted into a connector 202 of the SFP socket 200, the key 110 on the first protector 100 will be aligned with and engage the lock 118 on the second protector 102. Engagement of the lock 118 and key 110 will allow the SFP plug 120 to be fully inserted into the connector 202 in the proper orientation, minimizing damage to the SFP plug 120.

FIG. 2B illustrates how the first protector 100 and second protector 102 of FIGS. 1A and 1B may prevent the SFP plug 120 from being installed in an improper orientation that may cause damage to the SFP plug 120.

As illustrated in FIG. 2B, the first protector 100 and the second protector 102 are installed on the SFP plug 120 and the SFP socket 200, respectively, in the same manner described in connection with FIG. 2A. However, in FIG. 2B, the orientation of the SFP plug 120 is flipped, so that the “bottom” side 208 of the SFP plug 120 (e.g., a side on which the pins of the SFP plug 120 are exposed) is facing upward or facing toward the top of the SFP socket 200 (and toward the lock 118 of the second protector 102). In this orientation of the SFP plug 120, the key 110 of the first protector is facing downward, or away from the lock 118 of the second protector 102.

In this case, when the SFP plug 120 is inserted into a connector 202 of the SFP socket 200, the key 110 on the first protector 100 will not be aligned with and will not engage the lock 118 on the second protector 102. Failure of the lock 118 and key 110 to engage will cause the first protector 100 and the second protector 102 to act as a mechanical stop that prevents the SFP plug 120 from being fully inserted into the connector 202. For instance, even if the individual installing the SFP plug 120 attempted to force the SFP plug 120 into the connector 202, the SFP plug 120 would not be able to be fully inserted due to the key 110 not aligning with the lock 118. Thus, damage to the SFP plug 120 may be prevented even though the SFP plug 120 is oriented improperly for installation.

In one example, the first protector 100 and second protector 102 described above may be pre-installed on an SFP plug and SFP socket. That is, when an SFP socket is installed in a surface (e.g., by a technician dispatched by a fiber broadband service provider), the second protector 102 may be installed as part of the installation of the SFP socket. When equipment including an SFP plug is shipped to a customer (e.g., for self-installation of the equipment), the first protector 100 may be installed on the SFP plug prior to shipment, so that the first protector 100 is already positioned to ensure proper orientation of the SFP plug.

Alternatively, the first protector 100 and the second protector 102 may be shipped to the customer with the equipment and with instructions for installing the first protector 100 and the second protector 102 to ensure proper orientation of the SFP plug. In further examples, colors, patterns, or other visual indicators could be used to help ensure that the customer properly installs the first protector 100 and the second protector 102. For instance, stickers displaying the same color or same design could be placed on the key 110 and the lock 118 to help the customer properly align the key 110 with the lock 118.

In other examples still, a technician may install the second protector on an SFP socket, while the customer may install the first protector on the SFP plug.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. An apparatus comprising:
a first protector sized to fit around a small form factor pluggable plug, wherein the first protector comprises:
a first ring defining a first aperture; and
a key formed in an outside perimeter of the first ring; and
a second protector, separate from the first protector and sized to frame a small form factor pluggable socket, wherein the second protector comprises:
a second ring defining a second aperture; and
a lock formed in an inside perimeter of the second ring, wherein the lock is sized and shaped to engage the key.

2. The apparatus of claim 1, wherein each of the first protector and the second protector is formed of plastic.

3. The apparatus of claim 1, wherein at least one of: the first protector or the second protector is formed as a unitary piece.

4. The apparatus of claim 1, wherein at least one of: the first protector or the second protector is formed as at least two pieces that connect together.

5. The apparatus of claim 4, wherein the at least two pieces connect together via at least one of: a fastener or a magnet.

6. The apparatus of claim 1, wherein both of the first ring and the second ring have rectangular shapes.

7. The apparatus of claim 1, wherein the outside perimeter of the first ring is smaller than the inside perimeter of the second ring.

8. The apparatus of claim 1, wherein the key comprises a feature that protrudes from the outside perimeter of the first ring.

9. The apparatus of claim 8, wherein the lock comprises an indentation in the inside perimeter of the second ring that has a similar size and a similar shape as the feature.

10. The apparatus of claim 1, wherein a surface of the first aperture is rubberized.

11. An apparatus comprising:
a first protector sized to fit around a small form factor pluggable plug, wherein the first protector comprises:
a first ring defining a first aperture, wherein a surface of the first aperture is rubberized; and
a key formed in an outside perimeter of the first ring, wherein the key comprises a feature that protrudes from the outside perimeter of the first ring; and
a second protector, separate from the first protector and sized to frame a small form factor pluggable socket, wherein the second protector comprises:
a second ring defining a second aperture; and
a lock formed in an inside perimeter of the second ring, wherein the lock comprises an indentation in the inside perimeter of the second ring that has a similar size and a similar shape as the feature.

12. The apparatus of claim 11, wherein each of the first protector and the second protector is formed of plastic.

13. The apparatus of claim 11, wherein at least one of: the first protector or the second protector is formed as a unitary piece.

14. The apparatus of claim 11, wherein at least one of: the first protector or the second protector is formed as at least two pieces that connect together.

15. The apparatus of claim 14, wherein the at least two pieces connect together via at least one of: a fastener or a magnet.

16. The apparatus of claim 11, wherein the outside perimeter of the first ring is smaller than the inside perimeter of the second ring.

17. An apparatus comprising:
a small form factor pluggable plug for connecting to a small form factor pluggable connector; and
a protector fitted onto an end of the small form factor pluggable plug, the protector comprising:
a first ring defining a first aperture in which the small form factor pluggable plug fits; and
a key formed in an outside perimeter of the first ring, wherein the key is sized and shaped to engage a lock on a second protector that is installed on a small form factor pluggable connector.

18. The apparatus of claim 17, wherein a surface of the first aperture is rubberized.

19. The apparatus of claim 17, wherein the key comprises a feature that protrudes from the outside perimeter of the first ring.

20. The apparatus of claim 17, wherein the first ring has a rectangular shape.
